(19) United States
(12) Patent Application Publication
(10) Pub. No.: US 2026/0360376 A1
(43) Pub. Date: Nov. 12, 2026

(54) DEEP VOICE DETECTION METHOD AND APPARATUS

(71) Applicant: CHUNG ANG UNIVERSITY INDUSTRY ACADEMIC COOPERATION FOUNDATION, Seoul (KR)

(72) Inventors: Ji Won YOON, Seoul (KR); Eun Seo SEO, Seoul (KR)

(21) Appl. No.: 19/320,514

(22) Filed: Sep. 5, 2025

(30) Foreign Application Priority Data
May 12, 2025 (KR) 10-2025-0060863

(51) Int. Cl. G10L 19/02; G10L 15/02

(52) U.S. Cl. CPC G10L 19/0216; G10L 15/02; G10L 19/0204

(57) ABSTRACT

A deep voice detection apparatus includes a processor; and a memory connected to the processor, wherein the memory storing program instructions executed by the processor to decompose an input speech waveform into a plurality of first sub-bands having different frequency bands, calculate a feature of an emphasized second sub-band by applying an importance weight calculated based on an attention mechanism to an extracted feature for each of a plurality of second sub-bands having a preset frequency or more among the plurality of first sub-bands, generate a final output feature using the feature of the emphasized second sub-band and the feature extracted from the input speech waveform, and detect whether the input speech waveform is a deep voice using the final output feature.

### CROSS-REFERENCE TO RELATED APPLICATION

This application claims priority under 35 U.S.C. § 119 of Korean Patent Application No. 10-2025-0060863 filed on May 12, 2025, the entire contents of which are incorporated herein by reference.

### BACKGROUND

### (a) Technical Field

The present disclosure relates to a deep voice detection method and apparatus.

### (b) Background Art

Deep Voice refers to a technology that can copy and precisely reproduce a human voice using AI and deep learning technology, and the technology for creating the deep voice may be broadly divided into two types, that is, Text-to-Speech (TTS) and Voice Conversion (VC).

The Text-to-Speech (TTS) is a technology that converts text into human voice, and the Voice Conversion (VC) is a technology that converts the voice of an input speaker into the voice of a desired target without changing the text.

The deep voice technology is present in many aspects of our daily lives, including Apple's Siri, Google's Assistant, and AI that reads books.

These advancements in the deep voice technology are being utilized in a variety of ways, beyond simple voice synthesis, including natural conversations with users, information provision, and personalized content delivery. However, these advancements in technology pose risks to privacy, such as the spread of misinformation, identity theft, and voice phishing.

Advances in the audio synthesis technology (TTS and VC) have enabled increasingly sophisticated imitations of the human voice, and indeed, cases of voice phishing using deep voice technology have become increasingly frequent. Furthermore, privacy violations, such as the unauthorized use of voices of others for commercial purposes, are also on the rise.

However, most investigative police officers rely on directly seeing and hearing manipulated videos or audio to make judgments, and there is a lack of personnel capable of professionally investigating AI-based crimes, making it difficult to respond proactively.

Accordingly, the development of a detection model capable of more precisely identifying and responding to deep voices is essential.

### SUMMARY OF THE DISCLOSURE

In order to solve the problems of the above-mentioned related art, the present disclosure proposes a deep voice detection method and apparatus capable of identifying deep voice more precisely.

In order to achieve the above object, according to one embodiment of the present disclosure, there is provided a deep voice detection apparatus, including: a processor; and a memory connected to the processor, wherein the memory storing program instructions executed by the processor to decompose an input speech waveform into a plurality of first sub-bands having different frequency bands, calculate a feature of an emphasized second sub-band by applying an importance weight calculated based on an attention mechanism to an extracted feature for each of a plurality of second sub-bands having a preset frequency or more among the plurality of first sub-bands, generate a final output feature using the feature of the emphasized second sub-band and the feature extracted from the input speech waveform, and detect whether the input speech waveform is a deep voice using the final output feature.

The program instructions may decompose the input speech waveform into one low-frequency band and a plurality of high-frequency bands using a Discrete Wavelet Transform (DWT), and the plurality of second sub-bands may be defined as the plurality of high-frequency bands.

The program instructions may extract a feature vector of each of the plurality of second sub-bands, combine the extracted feature vectors into a single tensor to form a high-frequency feature matrix, and apply a linear transformation to the high-frequency feature matrix to calculate an attention score indicating an importance of each feature.

The program instructions may apply softmax to convert the attention score into a proportion of the total to calculate an attention weight vector, and perform an element-wise multiplication of the attention weight vector and the high-frequency feature matrix to calculate the emphasized second sub-band feature.

The final output feature may be generated by adding the emphasized second sub-band feature and the feature of the input speech waveform.

The final output feature may be input to a classifier to determine whether the input speech is the deep voice.

The plurality of second sub-bands may have a range of 1 kHz to 8 kHz.

According to another aspect of the present disclosure, there is provided a method for detecting deep voice by an apparatus including a processor and memory, the method including: decomposing an input speech waveform into a plurality of first sub-bands having different frequency bands; calculating a feature of an emphasized second sub-band by applying an importance weight calculated based on an attention mechanism to an extracted feature for each of a plurality of second sub-bands having a preset frequency or more among the plurality of first sub-bands; generating a final output feature using the feature of the emphasized second sub-band and the feature extracted from the input speech waveform; and detecting whether the input speech waveform is a deep voice using the final output feature.

According to still another aspect of the present disclosure, there is provided a computer program stored in a computer-readable recording medium for performing the above-described method.

According to the present disclosure, a structure specialized in the high-frequency region is provided, and thus, it is possible to effectively detect fine artifacts of fake voices, especially artifacts in the high frequency region, which have been overlooked by existing technologies.

In addition, according to the present disclosure, the present disclosure has high usability as it is compatible with the structure of existing voice forgery detection models (for example, CNN-based, Transformer-based) and can be easily inserted in a modular form, and can be expanded and applied to various voice security fields such as deepfake voice, TTS/VC determination, and spoofing detection.

### BRIEF DESCRIPTION OF THE DRAWINGS

FIG. 1 is a diagram showing the configuration of a deep voice detection apparatus according to a preferred embodiment of the present disclosure.

FIG. 2 is a diagram showing a deep voice detection process according to the present embodiment.

FIG. 3 is a diagram showing an architecture for deep voice detection according to the present embodiment.

### DETAILED DESCRIPTION

The present disclosure may be variously modified and have various embodiments, and thus, specific embodiments are illustrated in the drawings and described in detail in the detailed description. However, this is not intended to limit the present disclosure to specific embodiments, but rather to encompass all modifications, equivalents, and alternatives falling within the spirit and technical scope of the present disclosure.

The terminology used herein is merely used to describe specific embodiments and is not intended to limit the present disclosure. The singular expression includes the plural expression unless the context clearly indicates otherwise. In this specification, it should be understood that the term “comprise” or “have” indicates the presence of a feature, number, step, operation, component, part, or combination thereof described in the specification, but does not exclude in advance the possibility of the presence or addition of one or more other features, numbers, steps, operations, components, parts, or combinations thereof.

In addition, it is to be understood that the components of the embodiments described with reference to each drawing are not limitedly applied only to the embodiments, but may be implemented to be included in other embodiments within the scope in which the technical idea of the present disclosure is maintained, and that multiple embodiments may also be re-implemented as a single integrated embodiment even if a separate description is omitted.

In addition, when describing with reference to the attached drawings, identical components will be assigned identical or related reference numerals regardless of the drawing reference numbers, and redundant descriptions thereof will be omitted. When describing the present disclosure, if a detailed description of a related known technology is judged to unnecessarily obscure the gist of the present disclosure, the detailed description thereof will be omitted.

TTS and VC mainly generate the final waveform by attaching a GAN-based vocoder to the terminal, and in this case, the vocoder refers to a model that generates a waveform based on the input mel-spectrogram.

For the vocoder to generate accurate speech waveforms, the mel-spectrogram used during the training process of TTS and VC models must preserve as much information about the input speech waveform as possible. However, the process of converting the speech waveform into a mel-spectrogram causes the phase information contained in the original speech waveform and the detailed frequency variation information in the high-frequency region to be lost. This problem ultimately leads to artificial noise and artifacts in the high-frequency band when the speech waveform is generated through the vocoder.

To this end, the present embodiment proposes a structure designed to improve the performance of deepfake voice detection, that is, deep voice detection, by decomposing the input speech waveform into different frequency bands and then selectively emphasizing the features of the high-frequency region so that the detection model can effectively recognize the subtle artifacts of deepfake voice.

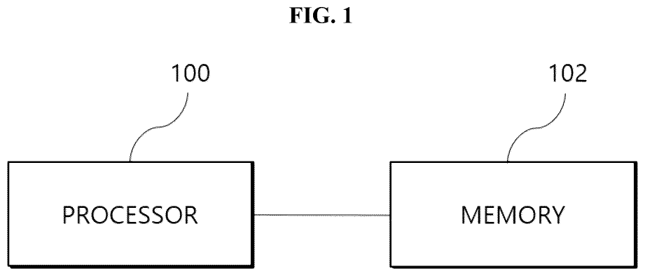

FIG. 1 is a diagram showing the configuration of a deep voice detection apparatus according to a preferred embodiment of the present disclosure.

As shown in FIG. 1, the deep voice detection apparatus according to the present embodiment may include a processor 100 and a memory 102.

Here, the processor 100 may include a central processing unit (CPU) capable of executing a computer program or a virtual machine, or the like.

The memory 102 may include a non-volatile storage device such as a fixed hard drive or a removable storage device. The removable storage device may include a compact flash unit, a USB memory stick, or the like. The memory 102 may also include volatile memory such as various random-access memories, and may be defined as a computer-readable recording medium.

Program instructions for detecting the deep voice are stored in the memory 102 according to the present embodiment.

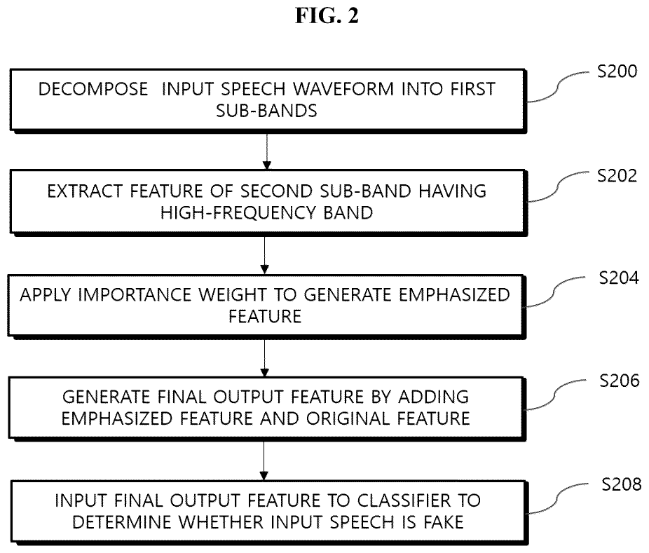

FIG. 2 is a diagram showing a deep voice detection process according to the present embodiment.

The process of FIG. 2 may define a process in which the processor 100 of the deep voice detection apparatus calls and executes the above-described program instructions.

Referring to FIG. 2, the deep voice detection apparatus according to the present embodiment decomposes an input speech waveform into sub-bands of different frequency bands (Step 200).

Step 200 may be a process of decomposing the input speech waveform into a plurality of first sub-bands including one low-frequency band and multiple high-frequency bands using a Discrete Wavelet Transform (DWT).

Here, the DWT is a signal processing technique that can simultaneously consider time-frequency resolution, and is a transformation method that partially maintains time information while decomposing the input signal into various frequency components.

Here, the low-frequency band may be in a range of 0 Hz to 1 kHz, and each of the plurality of frequency bands may have, for example, a range of 1 kHz to 2 kHz, a range of 2 kHz to 4 kHz, and a range of 4 kHz to 8 kHz, and may be expressed as in Mathematical Expression below.

{x_{cA3}>x_{cD3},x_{cD2},x_{cD1}}=DWT(x) [Mathematical Expression 1]

cA3 is a low-frequency component that represents the overall structure and energy distribution of a signal, cD3 is a band where low and high frequencies are mixed, containing smooth boundaries and change information, cD2 contains relatively many high-frequency components, capturing the rapid time change and phase information of the signal, and cD1 is mainly concentrated with high-frequency components and contains fine artifacts and distortion information that are easily lost during the vocoder restoration process.

Thereafter, the deep voice detection apparatus according to the present embodiment independently extracts features for each sub-band (Step 202).

Since the plurality of sub-bands decomposed in Step 200 contain information of different frequency bands, an independent feature extraction module is applied to each sub-band to effectively extract different features.

In the present embodiment, since artifacts included in the high-frequency components are extracted, features are extracted using only the second sub-bands, cD3, cD2, and cD1, corresponding to the high-frequency band, as in Mathematical Expression below.

h_{cD3}=f_{cD3}(x_{cD3}),h_{cD2}=f_{cD2}(x_{cD2}),h_{cD1}=f_{cD1}(x_{cD1}) [Mathematical Expression 2]
f_{cD3},f_{cD2},f_{cD1}: feature extraction module

The deep voice detection apparatus calculates the features of the second sub-band that are emphasized by applying the importance weights calculated based on the attention mechanism on the features extracted in Step 202 (Step 204).

Step 204 may be performed by a cross-attention integration module.

In the present embodiment, the importance of features extracted from high-frequency sub-bands is dynamically determined through learning, and the features are integrated in a way that emphasizes important information and reduces less important information. To this end, a selective emphasis module utilizing an attention mechanism is configured to calculate emphasized second sub-band features.

An importance weight is defined as an attention weight vector, and the process of calculating the emphasized second sub-band feature using the attention weight vector is described in detail below.

First, the feature vectors obtained in Step 202 are combined into one tensor to form a high-frequency feature matrix H.

$$H = [ \begin{matrix}{h}_{cD 3} \\ {h}_{cD 2} \\ {h}_{cD 1}\end{matrix} ] = {R}^{3 \times d} \qquad [ Mathematical Expression 3 ]$$

Afterwards, a linear transformation is applied to H to calculate an attention score indicating how important each sub-band is.

S=HW+b [Mathematical Expression 4]

As a result, the attention score represents the importance score for each sub-band.

According to the present embodiment, a mutual attention score is calculated with each second sub-band feature as key/value and with the features of the input speech waveform x as query, and thus, high-frequency features are trained to be considered important in the model.

$$Attention ( q , K , V ) = soft max ( \frac{{qK}^{T}}{\sqrt{{d}_{k}}} ) V , \qquad [ Mathematical Expression 5 ]$$

$$\cdot K = [ {h}_{cD 3} , {h}_{cD 2} , {h}_{cD 1} ]$$

$$\cdot V = [ {h}_{cD 3} , {h}_{cD 2} , {h}_{cD 1} ]$$

$$\cdot q = {f}_{raw} ( x )$$

$$\text{*} {f}_{raw} : feature extraction module$$

Softmax is applied to convert the importance of each sub-band according to the present embodiment into a proportion of the total.

$${a}_{i} = \frac{exp ( {S}_{i} )}{{\sum }_{j = 1}^{3} exp ( {S}_{j} )} for i ∈ cD 3 , cD 2 , cD 1 \qquad [ Mathematical Expression 6 ]$$

Here, α[α_{cD3},α_{cD2},α_{cD1}]∈R³ is the attention weight vector, which represents the relative importance of each sub-band.

Afterwards, the attention weight vector is multiplied by the features of each sub-band to generate an emphasized feature Hₒₘₚₕ=a⊙H.

Here, means element-wise multiplication. Important sub-bands are multiplied with high weights, and sub-bands with low importance are relatively weakened.

According to the present embodiment, the final output features are generated using the emphasized second sub-band features and the features extracted from the input speech waveform (Step 206).

In Step 206, the final output feature is generated by adding the emphasized feature Hₒₘₚₕ and the feature H of the input original waveform, as in Mathematical Expression below.

H_{final}=Hₒₘₚₕ+H [Mathematical Expression 7]

Step 206 is defined as a residual connection and the residual connection reflects original information in addition to information emphasized through attention, thereby preventing gradient vanishing and minimizing information loss.

Finally, the final output feature is input to a classifier to predict whether the input speech is fake or not (Step 208).

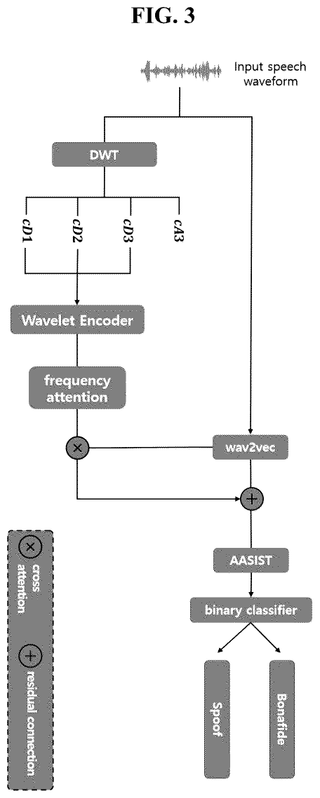

FIG. 3 is a diagram showing an architecture for deep voice detection according to the present embodiment.

FIG. 3 is a diagram showing an example of applying a method according to the present embodiment to the existing deep voice detection model.

As in the related art, the input speech waveform is decomposed into the plurality of first sub-bands through DWT while extracting features of the input speech waveform through a feature extractor such as wav2vec, features are extracted for each of the second sub-bands, cD3, cD2, and cD1, corresponding to the high-frequency band among the first sub-bands, the attention weight vector is calculated to calculate the emphasized second sub-band features, the emphasized second sub-band features are compressed, and thereafter, the attention weight vector for each of the second sub-bands is calculated.

According to the present embodiment, the feature vectors to which attention weight vectors for each sub-band are applied are input to a cross-attention-based integration module rather than a simple concat, so as to share mutual information and emphasize information of important sub-bands.

As described above, the cross-attention-based integrated module calculates the mutual attention score with each sub-band feature as the key/value and with the features of the input speech waveform x as the query, and is trained so that high-frequency features are considered important in the model.

Afterwards, the final output feature is generated through the residual connection that combines the features of the input speech waveform and the emphasized features, and thus, it is possible to determine whether the speech is fake.

The above-described embodiment of the present disclosure is disclosed for the purpose of illustration, and those skilled in the art with common knowledge of the present disclosure will be able to make various modifications, changes, and additions within the spirit and scope of the present disclosure, and such modifications, changes, and additions should be considered to fall within the scope of the following patent claims.

What is claimed is:

1. A deep voice detection apparatus, comprising:
a processor; and
a memory connected to the processor,
wherein the memory storing program instructions executed by the processor to decompose an input speech waveform into a plurality of first sub-bands having different frequency bands,
calculate a feature of an emphasized second sub-band by applying an importance weight calculated based on an attention mechanism to an extracted feature for each of a plurality of second sub-bands having a preset frequency or more among the plurality of first sub-bands,
generate a final output feature using the feature of the emphasized second sub-band and the feature extracted from the input speech waveform, and
detect whether the input speech waveform is a deep voice using the final output feature.

2. The deep voice detection apparatus of claim 1, wherein the program instructions decompose the input speech waveform into one low-frequency band and a plurality of high-frequency bands using a Discrete Wavelet Transform (DWT), and
the plurality of second sub-bands are defined as the plurality of high-frequency bands.

3. The deep voice detection apparatus of claim 1, wherein the program instructions
extract a feature vector of each of the plurality of second sub-bands,
combine the extracted feature vectors into a single tensor to form a high-frequency feature matrix, and
apply a linear transformation to the high-frequency feature matrix to calculate an attention score indicating an importance of each feature.

4. The deep voice detection apparatus of claim 3, wherein the program instructions
apply softmax to convert the attention score into a proportion of a total to calculate an attention weight vector, and
perform an element-wise multiplication of the attention weight vector and the high-frequency feature matrix to calculate an emphasized second sub-band feature.

5. The deep voice detection apparatus of claim 4, wherein the final output feature is generated by adding the emphasized second sub-band feature and the feature of the input speech waveform.

6. The deep voice detection apparatus of claim 1, wherein the final output feature is input to a classifier to determine whether the input speech waveform is the deep voice.

7. The deep voice detection apparatus of claim 1, wherein the plurality of second sub-bands have a range of 1 kHz to 8 kHz.

8. A method for detecting deep voice by an apparatus including a processor and memory, the method comprising:
decomposing an input speech waveform into a plurality of first sub-bands having different frequency bands;
calculating a feature of an emphasized second sub-band by applying an importance weight calculated based on an attention mechanism to an extracted feature for each of a plurality of second sub-bands having a preset frequency or more among the plurality of first sub-bands;
generating a final output feature using the feature of the emphasized second sub-band and the feature extracted from the input speech waveform; and
detecting whether the input speech waveform is a deep voice using the final output feature.

9. The method of claim 8, wherein the decomposing includes decomposing the input speech waveform into one low-frequency band and a plurality of high-frequency bands using a Discrete Wavelet Transform (DWT), and
the plurality of second sub-bands are defined as the plurality of high-frequency bands.

10. The method of claim 8, wherein the calculating includes
extracting a feature vector of each of the plurality of second sub-bands,
combining the extracted feature vectors into a single tensor to form a high-frequency feature matrix, and
applying a linear transformation to the high-frequency feature matrix to calculate an attention score indicating an importance of each feature.

11. The method of claim 10, wherein the calculating further includes
applying softmax to convert the attention score into a proportion of a total to calculate an attention weight vector, and
performing an element-wise multiplication of the attention weight vector and the high-frequency feature matrix to calculate an emphasized second sub-band feature.
